(19) United States
(12) Patent Application Publication
(10) Pub. No.: US 2026/0205989 A1
(43) Pub. Date: Jul. 16, 2026

(54) RECONFIGURABLE INTELLIGENT SURFACE STATE SIGNALING AND CONFIGURATION FOR POSITIONING AND SENSING

(71) Applicant: QUALCOMM Incorporated, San Diego, CA (US)

(72) Inventors: Marwen ZORGUI, San Diego, CA (US); Weimin DUAN, San Diego, CA (US); Alexandros MANOLAKOS, Athens (GR)

(21) Appl. No.: 19/138,057

(22) PCT Filed: Feb. 6, 2024
(86) PCT No.: PCT/US2024/014610

§ 371 Date: Jun. 11, 2025

(30) Foreign Application Priority Data
Mar. 1, 2023 (GR) 20230100174

(51) Int. Cl. H04W 64/00; G01S 5/02; H04W 52/02

(52) U.S. Cl. CPC H04W 64/00; G01S 5/0236; G01S 5/0273; H04W 52/0203

(57) ABSTRACT

In an aspect, a UE may receive, based on a first power state of a RIS, at least one of a positioning session configuration or a sensing session configuration. The UE may receive an indication of a power state schedule of the RIS. The UE may perform, based on at least one of the positioning session configuration or the sensing session configuration and the power state schedule of the RIS, at least one of a set of measurements or a set of transmissions for at least one of a positioning session or a sensing session.

### CROSS-REFERENCE TO RELATED APPLICATION

This application claims the benefit of Greece Patent Application Serial No. 20230100174, entitled “RECONFIGURABLE INTELLIGENT SURFACE STATE SIGNALING AND CONFIGURATION FOR POSITIONING AND SENSING” and filed on Mar. 1, 2023, which is expressly incorporated by reference herein in its entirety.

### TECHNICAL FIELD

The present disclosure relates generally to positioning systems, and more particularly, to positioning systems involving reconfigurable intelligent surfaces (RISs).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include memory and at least one processor coupled to the memory. The at least one processor, based at least in part on information stored in the memory may be configured to receive, based on a first power state of a RIS, at least one of a positioning session configuration or a sensing session configuration, to receive an indication of a power state schedule of the RIS, and to perform, based on at least one of the positioning session configuration or the sensing session configuration and the power state schedule of the RIS, at least one of a set of measurements or a set of transmissions for at least one of a positioning session or a sensing session.

In another aspect of the disclosure, a method, a computer-readable medium, and an apparatus at a UE are provided. The apparatus may include memory and at least one processor coupled to the memory. The at least one processor, based at least in part on information stored in the memory may be configured to transmit, based on a first power state of a RIS, at least one of a positioning session configuration or a sensing session configuration, and to transmit an indication of a power state schedule of the RIS.

In a further aspect of the disclosure, a method, a computer-readable medium, and an apparatus at a network node are provided. The apparatus may include memory and at least one processor coupled to the memory. The at least one processor, based at least in part on information stored in the memory may be configured to transmit, based on a first power state of a RIS, at least one of a positioning session configuration or a sensing session configuration, and to transmit an indication of a power state schedule of the RIS.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5A illustrates an example in which a network node transmits beamformed communication to UEs using directional beams in accordance with various aspects of the present disclosure.

FIG. 5B illustrates an example in which a network node transmits beamformed communication to UEs via a RIS in accordance with various aspects of the present disclosure.

FIG. 6 illustrates an example in which a RIS includes multiple subsets of multiple RIS elements, in accordance with various aspects of the present disclosure.

FIG. 7 is a diagram illustrating a RIS schedule in accordance with various aspects of the present disclosure.

FIG. 8 is a call flow diagram illustrating a method of wireless communication, in accordance with various aspects of this present disclosure.

FIG. 9 is a flowchart illustrating methods of wireless communication, in accordance with various aspects of the present disclosure.

FIG. 10 is a flowchart illustrating methods of wireless communication, in accordance with various aspects of the present disclosure.

FIG. 11 is a diagram illustrating an example of a hardware implementation for an example apparatus and/or network entity.

FIG. 12 is a diagram illustrating an example of a hardware implementation for an example network entity.

FIG. 13 is a diagram illustrating an example of a hardware implementation for an example network entity.

### DETAILED DESCRIPTION

Various aspects relate generally to positioning systems. Some aspects more specifically relate to positioning or radio frequency (RF) sensing based on the state of a RIS. In some examples, a network entity (e.g., a location management function (LMF)) may provide, to a UE, a positioning and/or sensing session configuration for a positioning and/or sensing session based on a state (e.g., a power state) of a RIS communicatively coupled or in proximity to the UE. The network entity may also provide a power state schedule of the RIS to the UE. The power state schedule may indicate one or more states of the RIS for a particular (e.g., future) time period. The UE may be configured to perform a positioning and/or a sensing action based on the positioning and/or sensing session configuration and the state(s) indicated in the power state schedule. For example, the UE may be configured to either perform a set of measurements (e.g., for reference signals received by the UE) or a set of transmissions (e.g., of reference signals) for the positioning and/or sensing session.

Particular aspects of the subject matter described in this disclosure can be implemented to realize one or more of the following potential advantages. In some examples, by utilizing the power state schedule, the network entity may adapt the behavior of the UE based on the state of the RIS. For example, the network entity may configure the UE to participate in a positioning and/or sensing session if a particular RIS is in a power-on state and may configure the UE to not participate in a positioning and/or sensing session if the RIS is in a power-off state. By selectively enabling the UE to participate or not participate in a positioning and/or sensing session, the UE may conserve compute resources (e.g., processing cycles, memory, power, etc.) by limiting the performance of measurements of reference signals and/or transmission of reference signals at times when the RIS is in a power-off state.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

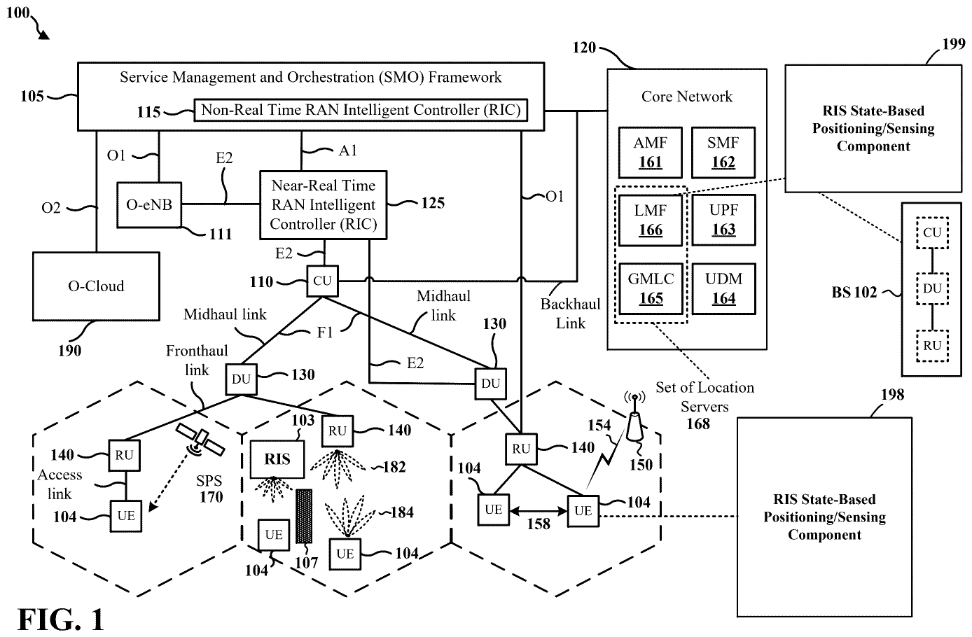

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The wireless communications system may further include a reconfigurable intelligent surface (RIS) 103. The RIS 103 may be employed to extend coverage, e.g., beamformed coverage, with lower power consumption. The RIS 103 may be composed of a larger number of uniformly distributed electrically controllable elements. Each RIS element may have a reconfigurable electromagnetic characteristic, e.g., a reflection coefficient. Depending on the combination of configured states of the elements, the RIS 103 may reflect and modify the incident radio waveform in a controlled manner, such as changing a reflected direction, changing a beam width, etc. The RIS 103 may function as a near passive device, and the reflection direction may be controlled by a control node, such as a base station or a UE. For example, the RIS 103 may reflect an impinging wave to a UE in a direction indicated by the base station.

In order to perform RIS-assisted communication/sensing/positioning functions, the base station or UE may use the position of the RIS 103. RIS information may be known by a network if the placement of the RIS 103 was planned by the network, and the base station 102 may transmit information about the RIS 103 to other nodes (e.g., UEs in the cell), e.g., in system information. UEs in the coverage of the cell may receive the system information in order to discover the presence of a RIS, the RIS position, the RIS capabilities, or other RIS information about a particular RIS.

In some aspects, the RIS 103 may reflect beamformed communication between a RU and a UE to avoid a blockage 107 that blocks a directional beam between the RU 140 and the UE 104.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The LMF 166 may also coordinate RF sensing sessions for a target entity, for example, by configuring nodes (e.g., TRPs or UEs) for the RF sensing sessions. The LMF 166 may also receive measurements and/or additional information from a node and determine a sensing result (e.g., a position of the target entity) based on the measurements and/or additional information. It is noted that the RF sensing session functionality described herein with reference to the LMF 166 may be implemented in an entity separate from the LMF 166, such as a sensing management function (SnMF). The SnMF may be included in the core network 120 or may be located at the base station 102. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a RIS state-based positioning/sensing component 198 that may be configured to receive, based on a first power state of a RIS, at least one of a positioning session configuration or a sensing session configuration, to receive an indication of a power state schedule of the RIS, and to perform, based on at least one of the positioning session configuration or the sensing session configuration and the power state schedule of the RIS, at least one of a set of measurements or a set of transmissions for at least one of a positioning session or a sensing session. In certain aspects, the UE 104 may have a RIS state-based positioning/sensing component 198 that may be configured to transmit, based on a first power state of a RIS, at least one of a positioning session configuration or a sensing session configuration, and to transmit an indication of a power state schedule of the RIS. In certain aspects, the base station 102 and/or the LMF 166 may have a RIS state-based positioning/sensing component 199 that may be configured to transmit, based on a first power state of a RIS, at least one of a positioning session configuration or a sensing session configuration, and to transmit an indication of a power state schedule of the RIS.

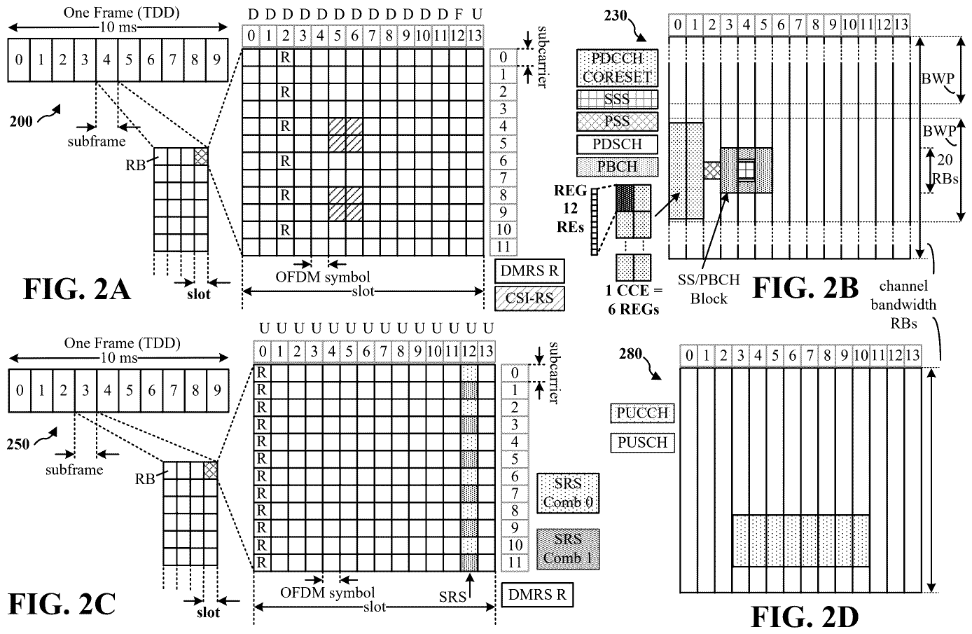

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

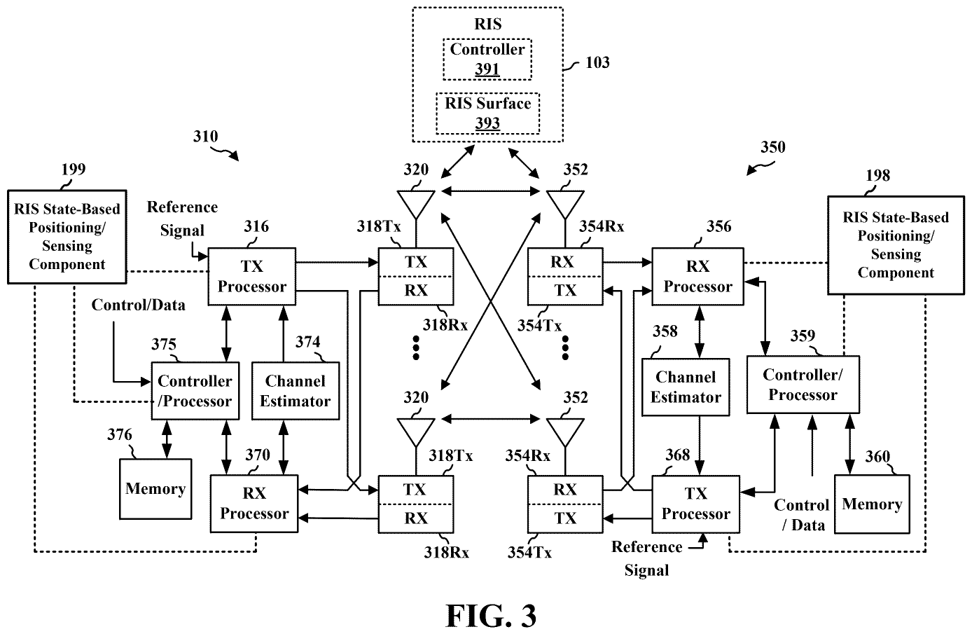

FIG. 3 is a block diagram of a base station 310 in communication with a UE 350 in an access network. In some aspects, communication between the base station 310 and the UE 350 may be provided by the RIS 103, such as described in connection with any of FIGS. 1, 3, 5A, 5B, and 6. The communication may be intelligently reflected, e.g., by a RIS surface 393 of the RIS 103. Discovery information, such as RIS capability information and/or position information for the RIS 103 may be transmitted by the controller 391, e.g., via sidelink.

In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the RIS state-based positioning/sensing component 198 of FIG. 1.

At least one of the TX processor 316, the RX processor 370, and the controller/processor 375 may be configured to perform aspects in connection with the RIS state-based positioning/sensing component 199 of FIG. 1.

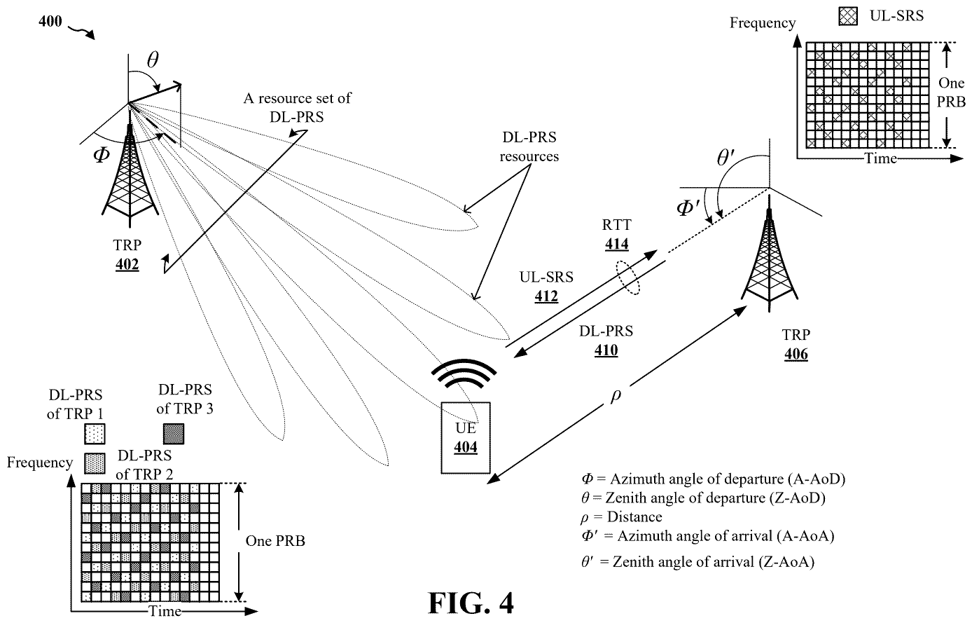

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and optionally DL-PRS-RSRP of the received signals) using assistance data received from the positioning server, and the TRPs 402, 406 measure the gNB Rx-Tx time difference measurements (and optionally UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and optionally DL-PRS-RSRP) of downlink signals received from multiple TRPs 402, 406 at the UE 404. The UE 404 measures the DL RSTD (and optionally DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and optionally UL-SRS-RSRP) at multiple TRPs 402, 406 of uplink signals transmitted from UE 404. The TRPs 402, 406 measure the UL-RTOA (and optionally UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

In addition to network-based UE positioning technologies, a wireless device (e.g., a UE, an access point (AP), etc.) may also be configured to include sensing capabilities, where the wireless device may be able to sense (e.g., detect and/or track) one or more objects or target entities of an area or in an environment based on radio frequencies. An environment may refer to a particular geographical area or place, especially as affected by human activity, or the circumstances, objects, or conditions by which one is surrounded. For example, a wireless device may include a radar capability (which may be referred to as “RF sensing” and/or “cellular-based RF sensing), where the wireless device may transmit reference signals (e.g., radar reference signals (RRSs)) and measure the reference signals reflected from one or more objects (e.g., structures, walls, living objects, and/or things in an environment, etc.). Based on the measurement, the wireless device may determine or estimate a distance between the wireless device and the one or more objects and/or obtain environmental information associated with its surrounding. In another example, a first wireless device may receive signals transmitted from a second wireless device, where the first wireless device may determine or estimate a distance between the first wireless device and the second wireless device based on the received signals. For example, a tracking device (e.g., a Bluetooth tracker, an item tracker, an asset tracking device, etc.) may be configured to regularly transmit signals (e.g., beacon signals) or small amounts of data to a receiving device, such that the receiving device may be able to monitor the location or the relative distance of the tracking device. As such, a user may be able to track the location of an item (e.g., a car key, a wallet, a remote control, etc.) by attaching the tracking device to the item. For purposes of the present disclosure, a device/apparatus that is capable of performing sensing (e.g., transmitting and/or receiving signals for detecting at least one object or for estimating the distance between the device and the at least one object) may be referred to as a “sensing device,” a “sensing node,” or a “sensing entity.” For example, a sensing device may be a UE, an AP device (e.g., a Wi-Fi router), a base station, a component of the base station, a TRP, a device capable of performing radar functions, etc. Furthermore, a target entity may be any object (e.g., a person, a vehicle, a UE, etc.) for which a positioning or sensing session is performed, for example, to determine a location thereof, a velocity thereof, a heading thereof, a physiological characteristic thereof, etc. In addition, a device/apparatus that is capable of transmitting signals to a sensing device for the sensing device to determine the location or the relative distance of the device/apparatus may be referred to as a “tracking device,” a “tracker,” or a “tag.”

For purposes of the present disclosure, a positioning session may be referred to the transmitting, the receiving, and the measuring of reference signals for the purposes of determining a positioning result or state (e.g., a location, a heading, a velocity, etc.) of a target entity. An RF sensing session may be referred to the transmitting, the receiving, and the measuring of reference signals for the purposes of determining a sensing result or state of an environment in which the target entity is included (e.g., a change in the environment), at least one physiological characteristic of a target entity, a location of the target entity, a velocity of the target entity, a heading of the target entity, etc.

Massive MIMO may help to increase throughput in a wireless communication system. Beamforming gain may be achieved through the use of active antenna units. Individual RF chains may be used per antenna port. The use of active antenna units (AAU) may increase power consumption. A RIS may be employed to extend coverage, e.g., beamformed coverage, with reduced power consumption. The RIS may include a larger number of uniformly distributed electrically controllable elements. Each RIS element may have a reconfigurable electromagnetic characteristic, e.g., a reflection coefficient. Depending on the combination of configured states of the elements, the RIS may reflect and modify the incident radio waveform in a controlled manner, such as changing a reflected direction, changing a beam width, etc. The RIS may function as a near passive device, and the reflection direction may be controlled by the base station. The RIS may reflect an impinging wave in a direction indicated by the base station to a UE.

A RIS may be deployed in wireless communication systems, including cellular systems, such as LTE, NR, etc. A RIS may alter the channel realization in a controlled manner, which may improve channel diversity. The increased diversity may provide robustness to channel blocking/fading. Compared to a wireless relay or repeater systems, a RIS may be more cost and energy efficient.

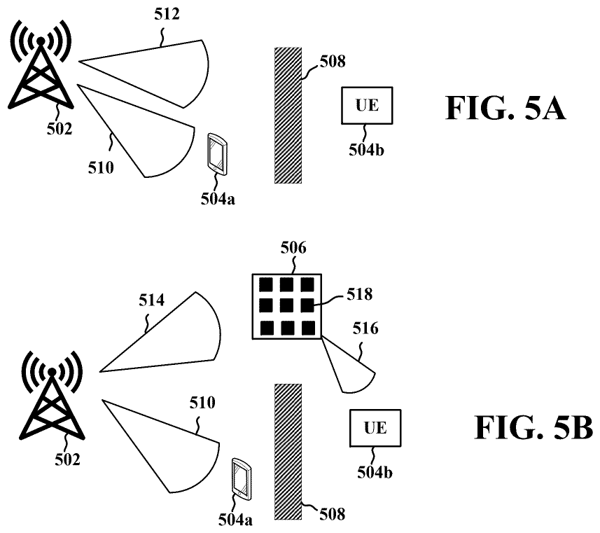

A base station may control the RIS to extend beam coverage and/or to address blockages between the base station and the UE. FIG. 5A illustrates an example in which a network node 502 transmits beamformed communication to UEs using directional beams 510 and 512. A UE 504a may be able to receive the direct transmission using the directional beam 510. However, FIG. 5A illustrates a blockage 508 that blocks the directional beam 512 from reception at the UE 504b. As illustrated in FIG. 5B, the network node 502 may transmit communication for the UE 504b using a directional beam 514 (which may be referred to as the impinging beam) to the RIS 506 for reflection over a directional beam 516 to the UE 504b. The network node 502 may indicate the direction of the beam 516 to the RIS 506, and the RIS 506 may reflect the impinging wave of the directional beam 514 in the direction of the directional beam 516.

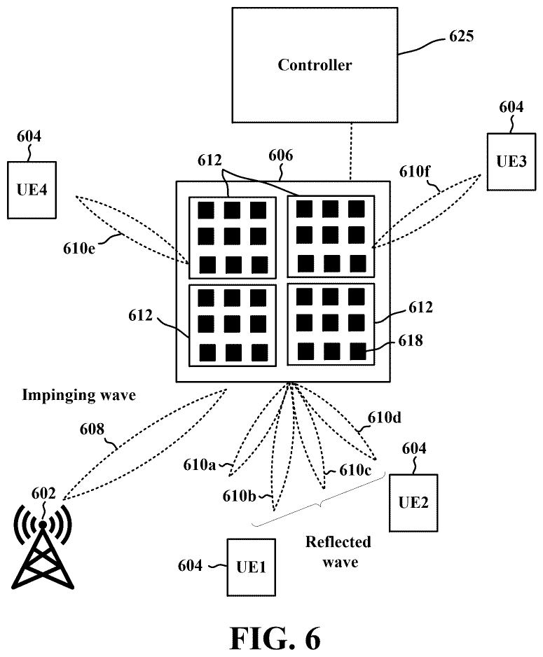

The RIS 506 may include multiple RIS elements 518 that are configured to adjust the reflected direction, the beam width, etc. FIG. 6 illustrates an example in which a RIS 606 includes multiple subsets 612 of multiple RIS elements 618. As illustrated, different subsets 612 of RIS elements 618 may serve different UEs 604. The RIS elements 618 may be controlled by a controller 625 at the RIS 606 based on control information received by the network node 602 and/or a particular UE of the different UEs 604. As described in connection with FIG. 5B, the network node 602 may indicate a beam direction (e.g., any of 610a, 610b, 610c, 610d, 610e, or 610f) to the RIS 606 for reflecting beamformed communication received as the impinging wave 608 to a particular UE of the different UEs 604 in a particular direction. The RIS 606 may similarly be controlled by a UE (e.g., a particular UE of the different UEs 604) for reflecting communication from the UE to a base station (e.g., the network node 602) and/or to another UE.

Using RISs in cellular systems may improve communication and positioning technologies. Existing RIS-aided positioning designs assume that a RIS is deployed for positioning purposes, where the control of the RIS is either done by a UE participating in the positioning session, or by the LMF. Such an approach is referred herein as RIS-aided positioning, as the RIS is being controlled for positioning purpose.

In contrast to RIS-aided positioning, RISs may be deployed for communication purposes to improve coverage. In this scenario, the RIS does not join the effort of positioning, and it is not controlled by a UE or the LMF. Instead, it is controlled by a network node for communication purposes. Moreover, for interference purposes and energy saving purposes at the RIS, the RIS may be turned on or off from the network node depending on the scenario. The RIS on/off behavior may be configured by the network node in a semi-static way. Alternatively, the RIS on/off behavior may be dynamically controlled by the network node (e.g., for interference control at neighbor cells or UEs). The “on” behavior may be indicative of a power-on state of the RIS, and the “off” behavior may be indicative of a power-off state or a standby state of the RIS. A power-on state may be a power state of the RIS in which power is supplied to the RIS, and the RIS is enabled to perform various RIS functionality as described herein, including reflecting and modifying an incident radio waveform in a controlled manner. A power-off state may be a power state of the RIS in which power is not supplied to the RIS (i.e., the RIS is de-activated and powered off such that it does not perform the RIS functionality described herein until it transitions to the power-on state)

Various aspects of the present disclosure are directed to signaling the RIS state from the network node to another network entity, such as a UE, the LMF, or a sensing entity. By communicating the states to an LMF or a UE, the LMF may adapt the behavior of the UE and/or a TRP based on the RIS state. Such techniques may enable RIS-state dependent configurations, whether the RIS state is dynamic or semi-static. In addition, for sidelink (SL)-positioning, where UE-Universal Mobile Telecommunications System (UMTS) terrestrial radio access network (UTRAN) (Uu) PRSs are not transmitted, the RIS state may be shared through SL signaling. It is noted that the various aspects described herein, such as the signaling of the RIS state may be extended to RF sensing. For purposes of the present disclosure, the RIS on/off behavior may be considered to be semi-static if the behavior is configured, for example, by a network node, via RRC signaling and may be considered to be dynamic if the behavior is configured, for example, by the network node, via DCI. The configuration provided by the network node to a RIS to enable semi-static behavior may be referred to as a semi-static configuration. The configuration provided by the network node to a RIS to enable dynamic behavior may be referred to as a dynamic configuration.

In some aspects, if the network node configures the RIS on/off behavior in a semi-static way, then the LMF or UE may be made aware of the RIS behavior and configure a positioning or RF sensing session according to the expected RIS behavior. For example, the network node may signal information indicative of a RIS on/off (or power state) schedule to the LMF using NR positioning protocol A (NRPPa), which is a protocol utilized for communicating between the LMF and the network node. The RIS (or power state) schedule may be in accordance with various forms. For example, the RIS schedule may include an on/off pattern starting from a particular slot n, where n is an integer greater than or equal to zero. In another example, the RIS schedule may include a window in which an on/off pattern is applied. When the configured window expires, a default RIS state may be configured or implicitly determined (e.g., either in the on state or the off state or the last time in the window). For instance, suppose the network node signals to the LMF the RIS behavior for the next 10 slots. If the LMF is unaware of the RIS behavior after those 10 slots, the LMF may implicitly determine (e.g., assume) that the behavior of the last slot in the window is maintained for subsequent slots. For instance, if the RIS is in the off state in the last slot in the window signaled to the LMF, then the LMF may assume that RIS stays in the off state after the last slot.

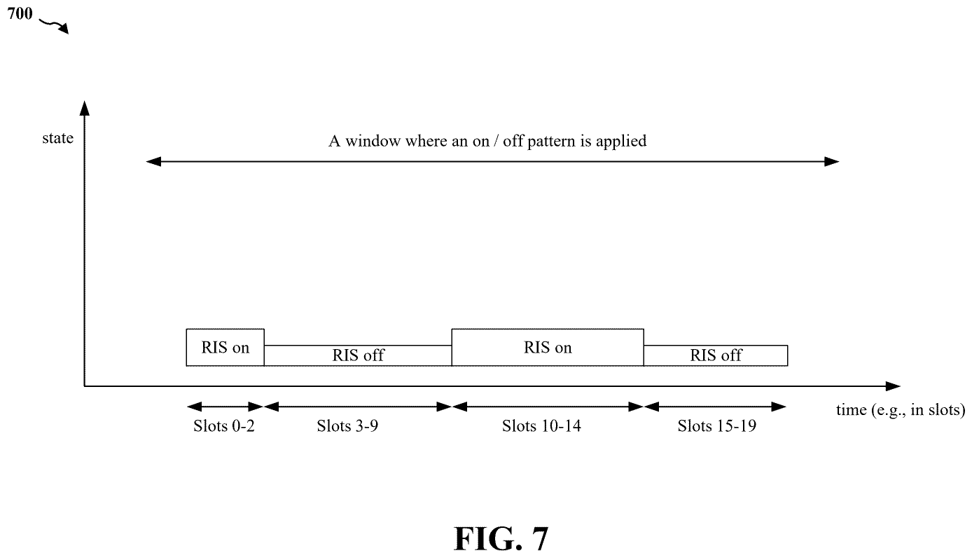

For example, FIG. 7 is a diagram 700 illustrating a RIS (or power state) schedule in accordance with various aspects of the present disclosure. As shown in FIG. 7, the network node may signal to the LMF information indicative of such a window. For instance, the information may indicate the length of the window (e.g., 20 slots) and the RIS state for each of the slots. In the example show in FIG. 7, the network node may signal to the LMF that the RIS state is on during slots 0-2 and 10-14 and that the RIS state is off during slots 3-9 and 15-19.

In some aspects, the RIS (or power state) schedule information may include information indicative of the operating beams of the RIS when it is in the on state. For example, the number of operating beams utilized during a particular set of slots while the RIS is in the on state (e.g., slots 0-2 or 10-14, as shown in FIG. 7), the boresight direction of such beams, the beam width or shape of such beams, etc., may be indicated in the RIS schedule information.

In some aspects, the RIS on/off (or power state) schedule may be signaled to the UE. In one aspect, the LMF may signal the RIS schedule to the UE using positioning SIBs (pos-SIBs) or LTE positioning protocol (LPP) signaling. In another aspect, the network node may signal the RIS schedule to the UE using layer 1 (L1), layer 2 (L2), and/or layer 3 (L3) signaling. Lower layer signaling may be utilized for dynamic RIS state changes, as it is faster to utilize lower layer signaling to provide the RIS state as it is dynamically changed.

In some aspects, the LMF configuration for the UE/TRP measurements and transmissions may be a function of the RIS state and the RIS operating beam (e.g., if the RIS supports multiple beams). Because the LMF knows the beam operations via the signaling from the network node, the LMF may configure the transmissions and the measurements based on the RIS state. The LMF may configure the network node with different quasi-co-location (QCL) relationships for PRS transmissions depending on the RIS state. For instance, if the RIS is in the on state, the LMF may configure the network node with a first QCL relationship. If the RIS in in the off state, the LMF may configure the network node with a second QCL relationship that is different than the first QCL relationship. The QCL relationship may also be beam-specific. For instance, if the RIS is using a first beam, then the LMF may configure the network node with a first QCL relationship. If the RIS is using a second beam, then the LMF may configure the network node with a second QCL relationship that is different than the first QCL relationship.

The LMF may configure the UE with different QCL relationships for the SRS transmissions depending on the RIS state. For instance, if the RIS is in the on state, the LMF may configure the UE with a first QCL relationship. If the RIS in in the off state, the LMF may configure the UE with a second QCL relationship that is different than the first QCL relationship. The QCL relationship may also be beam-specific. For instance, if the RIS is using a first beam, then the LMF may configure the UE with a first QCL relationship. If the RIS is using a second beam, then the LMF may configure the UE with a second QCL relationship that is different than the first QCL relationship.

For UE-assisted measurements reporting, the UE measurement and reporting configuration may be a function of the RIS state and RIS operating beam. For example, if the RIS is in the off state, the UE may report reference signal time difference (RSTD) values with no additional relative time differences (RTDs). If the RIS is in the on state, the UE may report RSTD values and at least one additional RTD. The UE may autonomously apply the RIS state-dependent configuration based on its knowledge of the RIS state.

In some aspects, a UE may signal/relay the dynamic or semi-static configuration of a RIS to nearby UEs through SL signaling. The nearby UEs may be out of coverage from the network node, but in coverage of the RIS, thereby being able to obtain the RIS state from a SL UE. The information of the RIS state may be useful for SL-based positioning, as it impacts the channels that the participating UEs are expected to observe, and therefore, impacts the choice for the SL-positioning session technique to be utilized. The RIS state information may be signaled at the beginning of a sidelink positioning session, for example, as part of sidelink control information (SCI), RRC, or PC5 (or UE-to-UE) signaling.

In some aspects, the UE may indicate the RIS state via a measurement report (e.g., a positioning or sensing measurement report). The measurement report may be either to the LMF (e.g., in the case of UE-assisted positioning), or to an SL UE (e.g., in the case of sidelink positioning). It is noted that the LMF may or may not be informed about the RIS states (e.g., for dynamic RIS changes, informing the LMF may not be efficient). Thus, tagging the measurements with the RIS state may help the LMF do the appropriate processing for the UE measurements.

In some aspects, the identities of the RISs whose states are communicated to the UE may be based on a list of discoverable RISs by the (e.g., in proximity to and/or that provide coverage to) the UE. The RISs may be discoverable via a RIS discovery technique. The UE may provide the list of discovered RISs to the network (e.g., the LMF or the network node), and the network may provide the on/off schedules of the RISs included in the list to the UE. In other aspects, the identities of the RISs whose states are communicated to the UE may be based on area identifier (ID) of the UE, followed by a potential handshake procedure between the UE and the RIS (e.g., to establish that the RIS is observable to the UE). In some aspects, the UE may provide a request to one or more other UEs to determine whether such UE(s) have the schedule of a discovered RIS. If such UE(s) have the schedule, such UE(s) may signal the schedule to the requesting UE.

As described herein, a sensing entity of an RF sensing session may also benefit from the knowledge of the RIS state and may configure transmissions/measurements accordingly.

In some aspects, the RIS dynamic or semi-static state may be communicated to the sensing entity (e.g., the LMF 166) in the core network. The sensing entity may configure TRPs and/or a UE with transmissions and/or receptions that are dependent on the RIS state. For example, certain UEs may be configured to participate in a sensing session when a certain RIS is in the on state. The participation may be either by transmitting a reference signal or monitoring another reference signal.

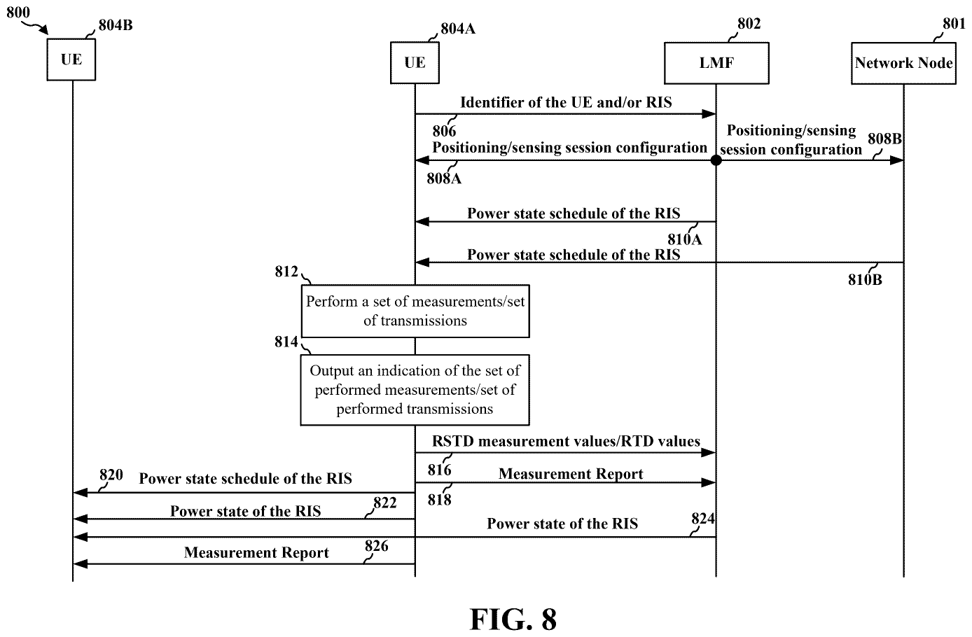

FIG. 8 depicts a call flow diagram 800 illustrating a method of wireless communication in accordance with various aspects of this present disclosure. As shown in FIG. 8, the diagram 800 includes a network node 801, an LMF 802, a first UE 804A, a second UE 804B. The first UE 804A and the second UE 804B may examples of the UE 104, the UE 350, the UE 404, the UE 504a, the UE 504b, and the different UEs 604. The network node 801 may be an example of the base station 102, the base station 310, the TRP 402, the TRP 406, the network node 502, or the network node 602. The LMF 802 may be an example of the LMF 166. Although aspects are described for the network node 801, the aspects may be performed by the network node 801 in aggregation and/or by one or more components of the network node 801 (e.g., such as a CU 110, a DU 130, and/or an RU 140). As shown in FIG. 8, at 806, the first UE 804A may transmit, to the LMF 802, at least one of an area ID of the first UE 804A or an identifier of a RIS to which the first UE 804A is communicatively coupled.

At 808A, the LMF 802 may provide, to the first UE 804A, based on a first power state of the RIS, at least one of a positioning session configuration or a sensing session configuration. The configuration may be based on a power state schedule received by the LMF 802 from the network node 801. Similarly, at 808B, the LMF 802, at 808B, may provide, to the network node 801, based on a first power state of the RIS, at least one of a positioning session configuration or a sensing session configuration. The configuration may be based on a power state schedule received by the LMF 802 from the network node 801. The positioning session configuration and/or sensing session configuration may indicate to the first UE 804A and/or the network node 801 to either perform a set of measurements for reference signals received by the first UE 804A and/or the network node 801 for a positioning session and/or sensing session, respectively, or transmit a set of reference signals for the positioning session and/or sensing session. In an aspect in which the LMF 802 provides a sensing session configuration to the first UE 804A, the sensing session configuration may configure the first UE 804A with a QCL for a measurement of a set of sensing reference signals based on a second power state of the RIS. In an aspect in which the LMF 802 provides a positioning session configuration to the network node 801, the positioning session configuration may configure the network node 801 with a QCL for a measurement of a set of PRSs based on a second power state of the RIS.

In some aspects, at 810A, the LMF 802 may provide an indication of a power state schedule of the RIS to the first UE 804A. In other aspects, at 810B, the LMF 802 may provide the indication of the power state schedule of the RIS to the network node 801 (and/or another network node). The indication of the power state schedule of the RIS may be received based at least on the area ID of the first UE 804A or the ID of the RIS received at 806.

In some aspects, the power state schedule indicated at 810A and/or 810B may include a pattern of one or more power-on states and one or more power-off states of the RIS, where the pattern is associated with a particular starting slot.

In some aspects, the power state schedule indicated at 810A and/or 810B may include a time window in which a pattern of one or more power-on states and one or more power-off states is applied to the RIS. In some aspects, the power state schedule indicated at 810A and 810B may include an indication of at least one of a number of beams utilized by the RIS, a shape of the beams utilized by the RIS, or a direction of the beams utilized by the RIS when the RIS is in a power-on state.

In an aspect in which the indication of the power state schedule is provided by the network node 801 at 810A, the network node 801 may provide the indication via one of L1 signaling, L2 signaling, or L3 signaling.

In an aspect in which the indication of the power state schedule is provided from the LMF 802 at 810B, the LMF 802 may provide the indication via one of a pos-SIB or LPP signaling.

In some aspects, the power state schedule indicated at 810A or 810B may be one of a dynamic power state schedule or a semi-static power state schedule.

At 812, the first UE 804A may perform, based on at least one of the positioning session configuration or the sensing session configuration and the power state schedule of the RIS, at least one of a set of measurements (for reference signals received by the first UE 804A, for example, by the network node 801, a RIS, or another UE (e.g., the second UE 804B)) or a set of transmissions (of reference signals to the network node 801, a RIS, and/or another UE (e.g., the second UE 804B)) for at least one of the positioning session or the sensing session.

At 814, the first UE 804A may output an indication of the set of performed measurements/set of performed transmissions. In some aspects, at 814, the first UE 804A may output the indication by transmitting, to the LMF 802, the indication of at least one of the set of performed measurements or the set of performed transmissions. In some aspects, at 814, the first UE 804A may output the indication by storing, in a memory or a cache, for example of the first UE 804A, the indication of at least one of the set of performed measurements or the set of performed transmissions.

At 816, the first UE 804A may transmit, based on a second power state of the RIS, at least one of a set of RSTD measurement values or a set of RTD values to the LMF 802. For instance, if the second power state (based on the power state schedule) of the RIS state is a power-off state, the first UE 804A may report the RSTD measurements values and no additional RTD values. However, if the second power state of the RIS is a power-on state, the first UE 804A may report the RSTD measurements and at least one additional RTD value.

In an aspect in which the LMF 802 is the LMF 166, at 818, a measurement report indicating a second power state of the RIS in accordance with the power state schedule is transmitted to the LMF 166.

In some aspects, the first UE 804A may transmit, to the second UE 804B, at 820, the power state schedule via one of SCI, RRC signaling, or UE-to-UE signaling.

In an aspect in which the second UE 804B is a sensing entity, at 822, the first UE 804A may transmit a second power state of the RIS in accordance with the power state schedule to the sensing entity.

In an aspect in which the second UE 804B is a sensing entity, at 824, the LMF 802 may transmit a second power state of the RIS in accordance with the power state schedule to the sensing entity.

In some aspects, at 826, the first UE 804A may transmit, to the second UE 804B, a measurement report indicating a second power state of the RIS in accordance with the power state schedule.

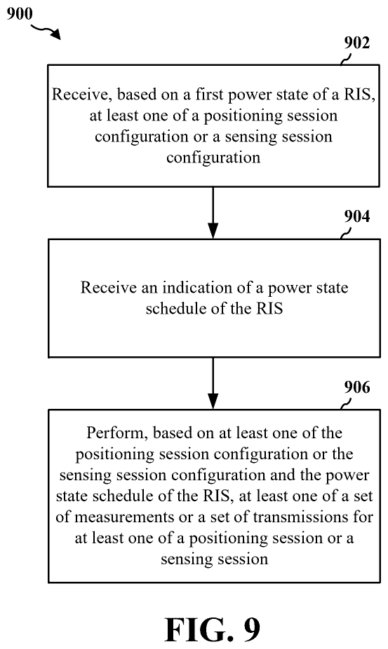

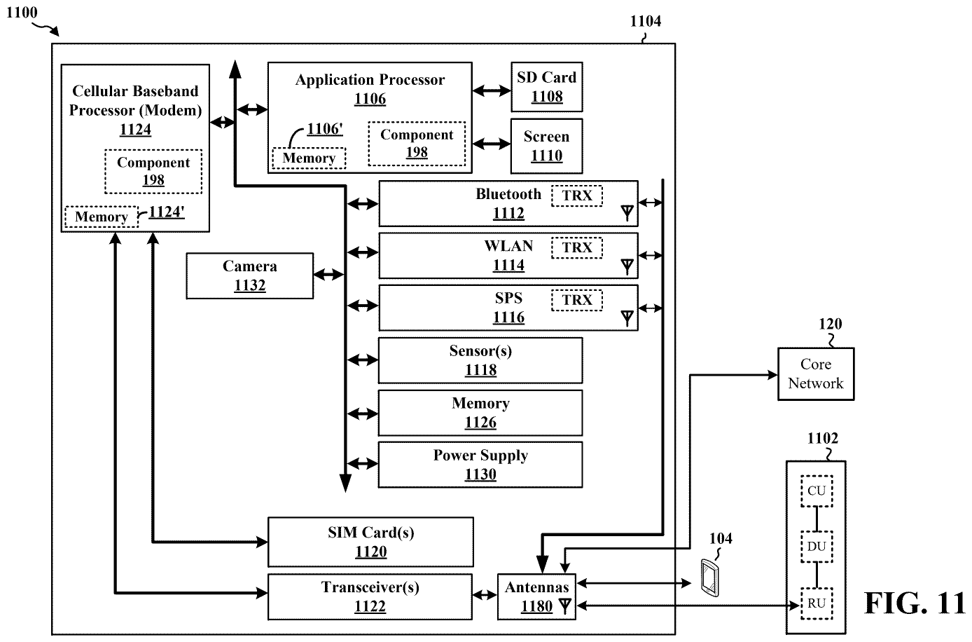

FIG. 9 is a flowchart 900 illustrating methods of wireless communication at a first UE in accordance with various aspects of the present disclosure. In some aspects, the UE may be the UE 104, 350, 404, 504a, 504b, the different UEs 604, the first UE 804A, or the second UE 804B, or the apparatus 1104 in the hardware implementation of FIG. 11.

At 902, the first UE may receive, based on a first power state of a RIS, at least one of a positioning session configuration or a sensing session configuration. For example, referring to FIG. 8, the first UE 804A, at 808A, may receive, based on a first power state of a RIS, at least one of a positioning session configuration or a sensing session configuration. In an aspect, 902 may be performed by the RIS state-based positioning/sensing component 198.

In some aspects, the first UE may receive at least one of the positioning session configuration or the sensing session configuration from at least one of a network entity, a network node, or a second UE. For example, referring to FIG. 8, the first UE 804A may receive at least one of the positioning session configuration or the sensing session configuration from at least one of a network entity (e.g., the LMF 802), the network node 801 or another UE (e.g., the second UE 804B).

At 904, the first UE may receive an indication of a power state schedule of the RIS. For example, referring to FIG. 8, at 810A, the first UE 804A may receive an indication of a power state schedule of the RIS from the LMF 802. Alternatively, the first UE 804A may receive, at 810B, the indication of the power state schedule from the network node 801. In an aspect, 904 may be performed by the RIS state-based positioning/sensing component 198.

In some aspects, the first UE may transmit at least one of an area ID of the first UE or an ID of the RIS, where the indication of the power state schedule of the RIS is received based at least on the area ID of the first UE or the ID of the RIS. For example, referring to FIG. 8, at 806, the first UE 804A may transmit at least one of an area ID of the first UE 804A or an ID of the RIS to the LMF 802, where the indication of the power state schedule of the RIS received at 810A is based at least on the area ID of the first UE 804A or the ID of the RIS.

In some aspects, the power state schedule may include a pattern of one or more power-on states and one or more power-off states of the RIS, where the pattern is associated with a particular starting slot. For example, referring to FIG. 8, the power state schedule indicated at 810A or 810B may include a pattern of one or more power-on states and one or more power-off states of the RIS, where the pattern is associated with a particular starting slot.

In some aspects, the power state schedule may include a time window in which a pattern of one or more power-on states and one or more power-off states is applied to the RIS. For example, referring to FIG. 8, the power state schedule indicated at 810A or 810B may include a time window in which a pattern of one or more power-on states and one or more power-off states is applied to the RIS.

In some aspects, the power state schedule may include an indication of at least one of a number of beams utilized by the RIS, a shape of the beams utilized by the RIS, or a direction of the beams utilized by the RIS when the RIS is in a power-on state. For example, referring to FIG. 8, the power state schedule indicated at 810A or 810B may include an indication of at least one of a number of beams utilized by the RIS, a shape of the beams utilized by the RIS, or a direction of the beams utilized by the RIS when the RIS is in a power-on state.

In some aspects, in an aspect in which the indication of the power state schedule is received from a network node, the indication may be received via one of L1 signaling, L2 signaling, or L3 signaling. For example, referring to FIG. 8, at 810B, the first UE 804A may receive the power state schedule from the network node 801 via one of L1 signaling, L2 signaling, or L3 signaling.

In some aspects, in an aspect in which the indication of the power state schedule is received from an LMF, the indication may be received via one of a pos-SIB or LPP signaling. For example, referring to FIG. 8, at 810A, the first UE 804A may receive the power state schedule from the LMF 802 via one of a pos-SIB or LPP signaling.

In some aspects, the power state schedule may be one of a dynamic power state schedule or a semi-static power state schedule. For example, referring to FIG. 8, the power state schedule indicated at 810A or 810B may be one of a dynamic power state schedule or a semi-static power state schedule. A dynamic power state schedule may be power state schedule that is configured, for example, by a network node, via DCI signaling, and a semi-static power state schedule may be a power state schedule that is configured, for example, by a network node, via RRC signaling.

At 906, the first UE may perform, based on at least one of the positioning session configuration or the sensing session configuration and the power state schedule of the RIS, at least one of a set of measurements or a set of transmissions for at least one of a positioning session or the sensing session. For example, referring to FIG. 8, at 812, the first UE 804A may perform, based on at least one of the positioning session configuration or the sensing session configuration and the power state schedule of the RIS, at least one of a set of measurements or a set of transmissions for at least one of a positioning session or the sensing session. In an aspect, 906 may be performed by the RIS state-based positioning/sensing component 198.

In some aspects, the first UE may output an indication of the set of performed measurements/set of performed transmissions. For example, referring to FIG. 8, at 814, the first UE 804A may output an indication of the set of performed measurements/set of performed transmissions.

In some aspects, the first UE may output the indication by transmitting the indication of at least one of the set of performed measurements or the set of performed transmissions. For example, referring to FIG. 8, at 814, the first UE 804A may output the indication by transmitting, to the LMF 802, the indication of at least one of the set of performed measurements or the set of performed transmissions.

In some aspects, the first UE may output the indication by storing, in a memory or a cache, the indication of at least one of the set of performed measurements or the set of performed transmissions. For example, referring to FIG. 8, the first UE 804A may output the indication by storing, in a memory or a cache, for example of the first UE 804A, the indication of at least one of the set of performed measurements or the set of performed transmissions.

In some aspects, at 814, the first UE 804A may output the indication by transmitting, to the LMF 802, the indication of at least one of the set of performed measurements or the set of performed transmissions. In some aspects, at 814, the first UE 804A may output the indication by storing, in a memory or a cache, for example of the first UE 804A, the indication of at least one of the set of performed measurements or the set of performed transmissions.

In some aspects, the first UE may transmit, based on a second power state of the RIS, at least one of a set of RSTD measurement values or a set of RTD values. For example, referring to FIG. 8, at 816, the first UE 804A may transmit, based on a second power state of the RIS, at least one of a set of RSTD measurement values or a set of RTD values to the LMF 802. For instance, if the second power state (based on the power state schedule) of the RIS state is a power-off state, the first UE 804A may report the RSTD measurements values and no additional RTD values. However, if the second power state of the RIS is a power-on state, the first UE 804A may report the RSTD measurements and at least one additional RTD value.

In some aspects, the first UE may transmit, to a second UE via one of SCI, RRC signaling, or UE-to-UE signaling, the power state schedule. For example, referring to FIG. 8, at 820, the first UE 804A may transmit, to the second UE 804B, the power state schedule via one of SCI, RRC signaling, or UE-to-UE signaling.

In some aspects, the first UE 804A may transmit, to an LMF, a measurement report indication a second power state of the RIS in accordance with the power state schedule. For example, referring to FIG. 8, at 818, the first UE 804A may transmit a measurement report indicating a second power state of the RIS in accordance with the power state schedule to the LMF 166.

In some aspects, the first UE 804A may transmit, to a second UE, a measurement report indication a second power state of the RIS in accordance with the power state schedule. For example, referring to FIG. 8, at 826, the first UE 804A may transmit a measurement report indicating a second power state of the RIS in accordance with the power state schedule to the second UE 804B.

In some aspects, the first UE may transmit a second power state of the RIS in accordance with the power state schedule to a sensing entity. For example, referring to FIG. 8, the first UE 804A may transmit a second power state of the RIS in accordance with the power state schedule to a sensing entity (e.g., the second UE 804B).

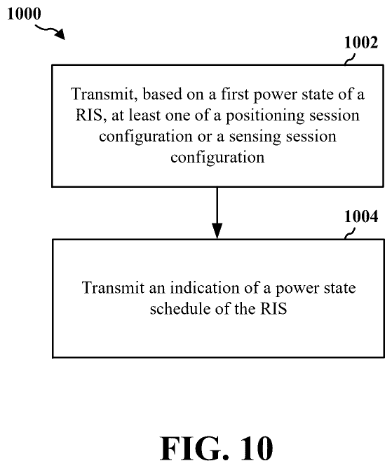

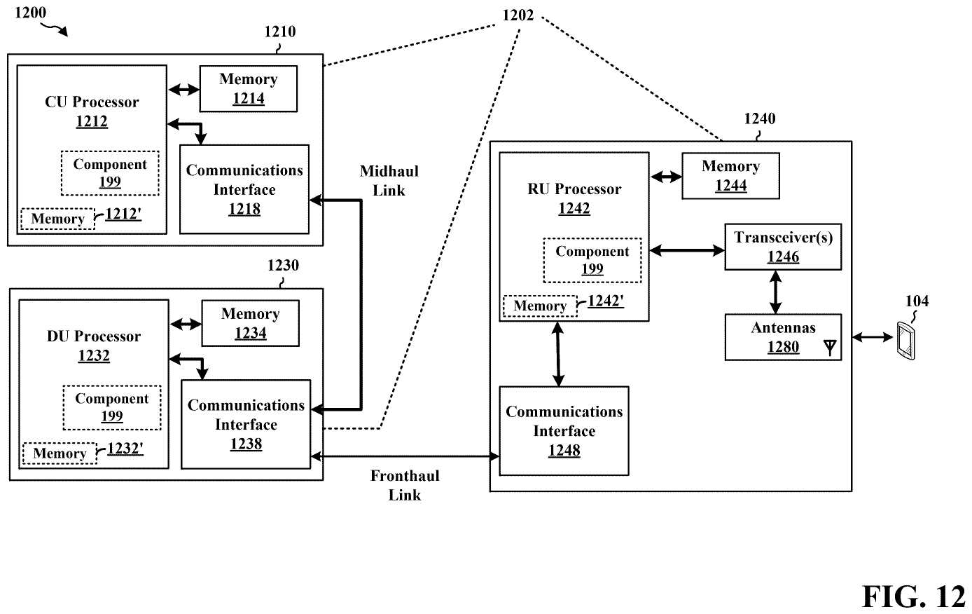

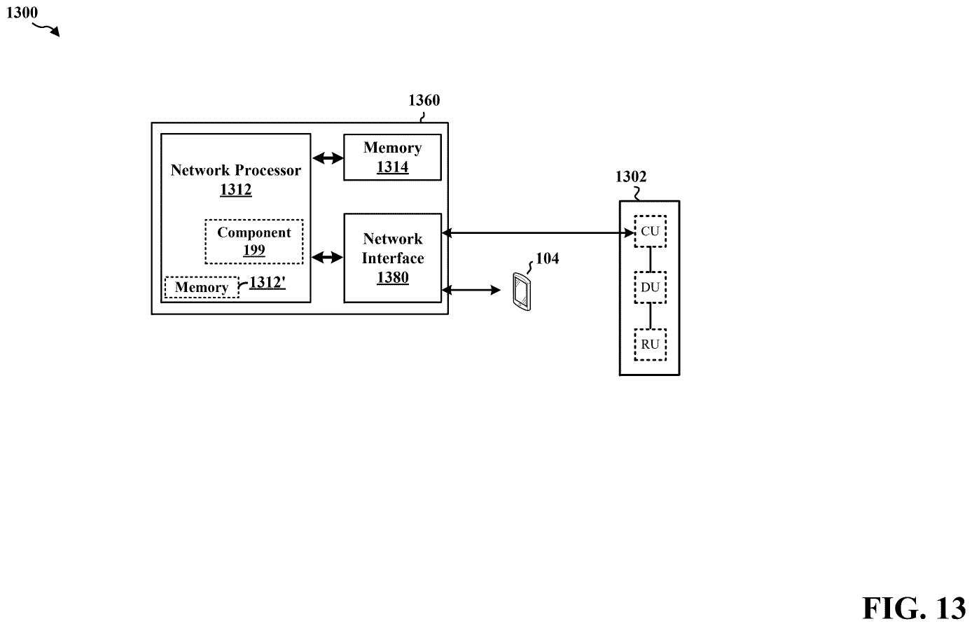

FIG. 10 is a flowchart 1000 illustrating methods of wireless communication at a network node in accordance with various aspects of the present disclosure. In some aspects, the first network node may be the LMF 166 or the LMF 802, the base station 104, the base station 310, the TRP 402, the TRP 406, the network node 502, the network node 602, or the network node 801, the UE 104, the UE 350, the UE 404, the UE 504a, the UE 504b, the different UEs 604, the first UE 804A, or the second UE 804B, the apparatus 1104 in the hardware implementation of FIG. 11, the network entity 1202 in the hardware implementation of FIG. 12, or the network entity 1360 in the hardware implementation of FIG. 13.

At 1002, the network node may transmit, based on a first power state of a RIS, at least one of a positioning session configuration or a sensing session configuration. For example, referring to FIG. 8, the LMF 802, at 808A, may transmit, based on a first power state of a RIS, at least one of a positioning session configuration or a sensing session configuration. In an aspect, 1002 may be performed by the RIS state-based positioning/sensing component 198 or the RIS-state based positioning/sensing component 199.

In some aspects, to transmit, based on the first power state of the RIS, at least one of the positioning session configuration or the sensing session configuration, the network node may transmit, for a base station, based on the first power state of the RIS, at least one of the positioning session configuration or the sensing session configuration. The positioning session configuration may configure the base station with a QCL for a measurement of a set of positioning reference signals based on a second power state of the RIS. For example, referring to FIG. 8, at 808B, to transmit, based on the first power state of the RIS, at least one of the positioning session configuration or the sensing session configuration, the LMF 802 may transmit, for the network node 801, based on the first power state of the RIS, at least one of the positioning session configuration or the sensing session configuration. The positioning session configuration may configure the base station with a QCL for a measurement of a set of positioning reference signals based on a second power state of the RIS.

In some aspects, to transmit, based on the first power state of the RIS, at least one of the positioning session configuration or the sensing session configuration, the network node may transmit, for a UE, based on the first power state of the RIS, at least one of the positioning session configuration or the sensing session configuration. The sensing session configuration may configure the UE with a QCL for a measurement of a set of sensing reference signals based on a second power state of the RIS. For example, referring to FIG. 8, at 808A, to transmit, based on the first power state of the RIS, at least one of the positioning session configuration or the sensing session configuration, the LMF 802 may transmit, for the first UE 804A, based on the first power state of the RIS, at least one of the positioning session configuration or the sensing session configuration. The sensing session configuration may configure the first UE 804A with a QCL for a measurement of a set of sensing reference signals based on a second power state of the RIS.

At 1004, the network node may transmit an indication of a power state schedule of the RIS. For example, referring to FIG. 8, the LMF 802, at 810A, may transmit an indication of a power state schedule of the RIS to the first UE 804A. In another example, the network node 801, at 810B, may transmit an indication of a power state schedule of the RIS to the first UE 804A. In an aspect, 1004 may be performed by the RIS state-based positioning/sensing component 198 or the RIS-state based positioning/sensing component 199.

In an aspect in which the network node is a base station, the indication of the power state schedule may be transmitted from the base station via one of L1 signaling, L2 signaling, or L3 signaling. For example, referring to FIG. 8, at 810B, the network node 801 may transmit the indication of the power state schedule to the first UE 804A via one of L1 signaling, L2 signaling, or L3 signaling.

In an aspect in which the network node is an LMF, the indication of the power state schedule may be transmitted from the LMF via one of a pos-SIB or LPP signaling. For example, referring to FIG. 8, at 810BA, the LMF 802 may transmit the indication of the power state schedule to the first UE 804A via one of a pos-SIB or LPP signaling.

In some aspects, the power state schedule may include a pattern of one or more power-on states and one or more power-off states of the RIS, where the pattern is associated with a particular starting slot. For example, referring to FIG. 8, the power state schedule indicated at 810A or 810B may include a pattern of one or more power-on states and one or more power-off states of the RIS, where the pattern is associated with a particular starting slot.

In some aspects, the power state schedule may include a time window in which a pattern of one or more power-on states and one or more power-off states is applied to the RIS. For example, referring to FIG. 8, the power state schedule indicated at 810A or 810B may include a time window in which a pattern of one or more power-on states and one or more power-off states is applied to the RIS.

In some aspects, the power state schedule may include an indication of at least one of a number of beams utilized by the RIS, a shape of the beams utilized by the RIS, or a direction of the beams utilized by the RIS when the RIS is in a power-on state. For example, referring to FIG. 8, the power state schedule indicated at 810A or 810B may include an indication of at least one of a number of beams utilized by the RIS, a shape of the beams utilized by the RIS, or a direction of the beams utilized by the RIS when the RIS is in a power-on state.

In some aspects, the network node may receive a measurement report indicating a second power state of the RIS in accordance with the power state schedule. For example, referring to FIG. 8, at 818, the LMF 802 may receive a measurement report from the first UE 804A.

In some aspects, the network node may receive at least one of an area ID of a UE or an ID of the RIS, where the indication of the power state schedule of the RIS is transmitted based at least on the area ID of the UE or the ID of the RIS. For example, referring to FIG. 8, at 806, the LMF 802 may receive at least one of an area ID of the first UE 804A or an ID of the RIS, where the indication of the power state schedule of the RIS transmitted at 810A is based at least on the area ID of the first UE 804A or the ID of the RIS.

In an aspect in which the network node is a UE, the UE may transmit a second power state of the RIS in accordance with the power state schedule to a sensing entity. For example, referring to FIG. 8, at 820, the first UE 804A may transmit a second power state of the RIS in accordance with the power state schedule to a sensing entity (e.g., the second UE 804B).

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include a cellular baseband processor 1124 (also referred to as a modem) coupled to one or more transceivers 1122 (e.g., cellular RF transceiver). The cellular baseband processor 1124 may include on-chip memory 1124′. In some aspects, the apparatus 1104 may further include one or more subscriber identity modules (SIM) cards 1120 and an application processor 1106 coupled to a secure digital (SD) card 1108 and a screen 1110. The application processor 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor 1124 communicates through the transceiver(s) 1122 via one or more antennas 1180 with the UE 104, the core network 120, and/or with an RU associated with a network entity 1102. The cellular baseband processor 1124 and the application processor 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor 1124 and the application processor 1106 are each responsible for general processing, including the execution of software stored on the computer-readable medium/memory. The software, when executed by the cellular baseband processor 1124/application processor 1106, causes the cellular baseband processor 1124/application processor 1106 to perform the various functions described supra. The computer-readable medium/memory may also be used for storing data that is manipulated by the cellular baseband processor 1124/application processor 1106 when executing software. The cellular baseband processor 1124/application processor 1106 may be a component of the UE 350 and may include the memory 360 and/or at least one of the TX processor 368, the RX processor 356, and the controller/processor 359. In one configuration, the apparatus 1104 may be a processor chip (modem and/or application) and include just the cellular baseband processor 1124 and/or the application processor 1106, and in another configuration, the apparatus 1104 may be the entire UE (e.g., see UE 350 of FIG. 3) and include the additional modules of the apparatus 1104.

As discussed supra, the component 198 may be configured to receive, based on a first power state of a RIS, at least one of a positioning session configuration or a sensing session configuration, to receive an indication of a power state schedule of the RIS, and to perform, based on at least one of the positioning session configuration or the sensing session configuration and the power state schedule of the RIS, at least one of a set of measurements or a set of transmissions for at least one of a positioning session or a sensing session. The component 198 may also be configured to transmit, based on a first power state of a RIS, at least one of a positioning session configuration or a sensing session configuration, and to transmit an indication of a power state schedule of the RIS. The component 198 may be configured to perform any of the aspects described in connection with the flowcharts in FIGS. 9 and 10 and/or the aspects performed by the first UE 804A in the communication flow in FIG. 8. The component 198 may be within the cellular baseband processor 1124, the application processor 1106, or both the cellular baseband processor 1124 and the application processor 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1104 may include a variety of components configured for various functions. In one configuration, the apparatus 1104, and in particular the cellular baseband processor 1124 and/or the application processor 1106, may include means for receiving, based on a first power state of a RIS, at least one of a positioning session configuration or a sensing session configuration, means for receiving an indication of a power state schedule of the RIS, and means for performing, based on at least one of the positioning session configuration or the sensing session configuration and the power state schedule of the RIS, at least one of a set of measurements or a set of transmissions for at least one of a positioning session or a sensing session. In another configuration, the apparatus 1104, and in particular the cellular baseband processor 1124 and/or the application processor 1106, may include means for transmitting, based on a first power state of a RIS, at least one of a positioning session configuration or a sensing session configuration, and means for transmitting an indication of a power state schedule of the RIS. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include a CU processor 1212. The CU processor 1212 may include on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include a DU processor 1232. The DU processor 1232 may include on-chip memory 1232′. In some aspects, the DU 1230 may further include additional memory modules 1234 and a communications interface 1238. The DU 1230 communicates with the RU 1240 through a fronthaul link. The RU 1240 may include an RU processor 1242. The RU processor 1242 may include on-chip memory 1242′. In some aspects, the RU 1240 may further include additional memory modules 1244, one or more transceivers 1246, antennas 1280, and a communications interface 1248. The RU 1240 communicates with the UE 104. The on-chip memory 1212′, 1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to transmit, based on a first power state of a RIS, at least one of a positioning session configuration or a sensing session configuration, and to transmit an indication of a power state schedule of the RIS. The component 199 may be configured to perform any of the aspects described in connection with the flowchart in FIG. 10 and/or the aspects performed by the network node 801 in the communication flow in FIG. 8. The component 199 may be within one or more processors of one or more of the CU 1210, DU 1230, and the RU 1240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1202 may include a variety of components configured for various functions. In one configuration, the network entity 1202 may include means for transmitting, based on a first power state of a RIS, at least one of a positioning session configuration or a sensing session configuration, and means for transmitting an indication of a power state schedule of the RIS. The means may be the component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

FIG. 13 is a diagram 1300 illustrating an example of a hardware implementation for a network entity 1360. In one example, the network entity 1360 may be within the core network 120. The network entity 1360 may include a network processor 1312. The network processor 1312 may include on-chip memory 1312′. In some aspects, the network entity 1360 may further include additional memory modules 1314. The network entity 1360 communicates via the network interface 1380 directly (e.g., backhaul link) or indirectly (e.g., through a RIC) with the CU 1302 and the UE 104. The on-chip memory 1312′ and the additional memory modules 1314 may each be considered a computer-readable medium/memory. Each computer-readable medium/memory may be non-transitory. The processor 1312 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to transmit, based on a first power state of a RIS, at least one of a positioning session configuration or a sensing session configuration, and to transmit an indication of a power state schedule of the RIS. The component 199 may be configured to perform any of the aspects described in connection with the flowchart in FIG. 10 and/or the aspects performed by the LMF 802 in the communication flow in FIG. 8. The component 199 may be within the processor 1312. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1360 may include a variety of components configured for various functions. In one configuration, the network entity 1360 may include means for transmitting, based on a first power state of a RIS, at least one of a positioning session configuration or a sensing session configuration, and means for transmitting an indication of a power state schedule of the RIS. The means may be the component 199 of the network entity 1360 configured to perform the functions recited by the means.

Various aspects relate generally to positioning systems. Some aspects more specifically relate to positioning or RF sensing based on the state of a RIS. In some examples, a network entity (e.g., a location management function (LMF)) may provide, to a UE, a positioning and/or sensing session configuration for a positioning and/or sensing session based on a state (e.g., a power state) of a RIS communicatively coupled or in proximity to the UE. The network entity may also provide a power state schedule of the RIS to the UE. The power state schedule may indicate one or more states of the RIS for a particular (e.g., future) time period. The UE may be configured to perform a positioning and/or a sensing action based on the positioning and/or sensing session configuration and the state(s) indicated in the power state schedule. For example, the UE may be configured to either perform a set of measurements (e.g., for reference signals received by the UE) or a set of transmissions (e.g., of reference signals) for the positioning and/or sensing session.

Particular aspects of the subject matter described in this disclosure can be implemented to realize one or more of the following potential advantages. In some examples, by utilizing the power state schedule, the network entity may adapt the behavior of the UE based on the state of the RIS. For example, the network entity may configure the UE to participate in a positioning and/or sensing session if a particular RIS is in a power-on state and may configure the UE to not participate in a positioning and/or sensing session if the RIS is in a power-off state. By selectively enabling the UE to participate or not participate in a positioning and/or sensing session, the UE may conserve compute resources (e.g., processing cycles, memory, power, etc.) by limiting the performance of measurements of reference signals and/or transmission of reference signals at times when the RIS is in a power-off state.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a first UE, including receiving, based on a first power state of a RIS, at least one of a positioning session configuration or a sensing session configuration; receiving an indication of a power state schedule of the RIS; and performing, based on at least one of the positioning session configuration or the sensing session configuration and the power state schedule of the RIS, at least one of a set of measurements or a set of transmissions for at least one of a positioning session or a sensing session.
Aspect 2 is the method of aspect 1, further including: outputting an indication of at least one of the set of performed measurements or the set of performed transmissions for at least one of the positioning session or the sensing session.
Aspect 3 is the method of aspect 2, where outputting the indication of at least one of the set of performed measurements or the set of performed transmissions includes: transmitting the indication of at least one of the set of performed measurements or the set of performed transmissions.
Aspect 4 is the method of aspect 2, where outputting the indication of at least one of the set of performed measurements or the set of performed transmissions includes: storing, in a first memory or a cache, the indication of at least one of the set of performed measurements or the set of performed transmissions.
Aspect 5 is the method of any of aspects 1 to 4, where the power state schedule includes a pattern of one or more power-on states and one or more power-off states of the RIS, where the pattern is associated with a particular starting slot.
Aspect 6 is the method of any of aspects 1 to 5, where the power state schedule includes a time window in which a pattern of one or more power-on states and one or more power-off states is applied to the RIS.
Aspect 7 is the method of any of aspects 1 to 6, where the power state schedule includes an indication of at least one of a number of beams utilized by the RIS, a shape of the beams utilized by the RIS, or a direction of the beams utilized by the RIS when the RIS is in a power-on state.
Aspect 8 is the method of any of aspects 1 to 7, where the indication of the power state schedule is received from a network node via one of L1 signaling, L2 signaling, or L3 signaling.
Aspect 9 is the method of any of aspects 1 to 8, where the indication of the power state schedule is received from an LMF via one of a pos-SIB or LPP signaling.
Aspect 10 is the method of any of aspects 1 to 9, further including: transmitting, based on a second power state of the RIS, at least one of a set of RSTD measurement values or a set of RTD values.
Aspect 11 is the method of any of aspects 1 to 10, where the power state schedule is one of a dynamic configuration or a semi-static configuration.
Aspect 12 is the method of any of aspects 1 to 11, further including: transmitting, to a second UE via one of SCI, RRC signaling, or UE-to-UE signaling, the power state schedule.
Aspect 13 is the method of any of aspects 1 to 12, further including: transmitting, to an LMF, a measurement report indicating a second power state of the RIS in accordance with the power state schedule.
Aspect 14 is the method of any of aspects 1 to 13, further including: transmitting, to a second UE, a measurement report indicating a second power state of the RIS in accordance with the power state schedule.
Aspect 15 is the method of any of aspects 1 to 14, where receiving at least one of the positioning session configuration or the sensing session configuration includes: receiving at least one of the positioning session configuration or the sensing session configuration from at least one of a network entity, a network node, or a second UE.
Aspect 16 is the method of any of aspects 1 to 15, further including: transmitting at least one of an area identifier of the first UE or an identifier of the RIS, where the indication of the power state schedule of the RIS is received based at least on the area identifier of the first UE or the identifier of the RIS.
Aspect 17 is the method of any of aspects 1 to 16, further including: transmitting a second power state of the RIS in accordance with the power state schedule to a sensing entity.
Aspect 18 is a method of wireless communication at a network node, including transmitting, based on a first power state of a RIS, at least one of a positioning session configuration or a sensing session configuration; and transmitting an indication of a power state schedule of the RIS.
Aspect 19 is the method of aspect 18, where the network node is an LMF, a base station, or a UE.
Aspect 20 is the method of aspect 19, where the network node is the base station, and where the indication of the power state schedule is transmitted from the base station via one of L1 signaling, L2 signaling, or L3 signaling.
Aspect 21 is the method of aspect 19, where the network node is the LMF, and where the indication of the power state schedule is transmitted by the LMF via one of a pos-SIB or LPP signaling.
Aspect 22 is the method of any of aspects 18 to 21, where transmitting, based on the first power state of the RIS, at least one of the positioning session configuration or the sensing session configuration includes: transmitting, for a base station, based on the first power state of the RIS, at least one of the positioning session configuration or the sensing session configuration, where the positioning session configuration configures the base station with a QCL for a measurement of a set of positioning reference signals based on a second power state of the RIS.
Aspect 23 is the method of any of aspects 18 to 21, where transmitting, based on the first power state of the RIS, at least one of the positioning session configuration or the sensing session configuration includes: transmitting, for a UE, based on the first power state of the RIS, at least one of the positioning session configuration or the sensing session configuration, where the sensing session configuration configures the UE with a QCL for a measurement of a set of sensing reference signals based on a second power state of the RIS.
Aspect 24 is the method of any of aspects 18 to 23, where the power state schedule includes a pattern of one or more power-on states and one or more power-off states of the RIS, where the pattern is associated with a particular starting slot.
Aspect 25 is the method of any of aspects 18 to 24, where the power state schedule includes a time window in which a pattern of one or more power-on states and one or more power-off states is applied to the RIS.
Aspect 26 is the method of any of aspects 18 to 25, where the power state schedule includes an indication of at least one of a number of beams utilized by the RIS, a shape of the beams utilized by the RIS, or a direction of the beams utilized by the RIS when the RIS is in a power-on state.
Aspect 27 is the method of any of aspects 18 to 26, further including: receiving a measurement report indicating a second power state of the RIS in accordance with the power state schedule.
Aspect 28 is the method of any of aspects 18 to 27, further including: receiving at least one of an area identifier of a UE or an identifier of the RIS, where the indication of the power state schedule of the RIS is transmitted based at least on the area identifier of the UE or the identifier of the RIS.
Aspect 29 is the method of any of aspects 18 to 28, further including: transmitting a second power state of the RIS in accordance with the power state schedule to a sensing entity.
Aspect 30 is an apparatus for wireless communication at a first UE. The apparatus includes memory; and at least one processor coupled to the memory and, based at least in part on information stored in the memory, the at least one processor is configured to implement any of aspects 1 to 17.
Aspect 31 is the apparatus of aspect 30, further including at least one of a transceiver or an antenna coupled to the at least one processor.
Aspect 32 is an apparatus for wireless communication at a network node. The apparatus includes memory; and at least one processor coupled to the memory and, based at least in part on information stored in the memory, the at least one processor is configured to implement any of aspects 18 to 29.
Aspect 33 is the apparatus of aspect 32, further including at least one of a transceiver or an antenna coupled to the at least one processor.
Aspect 34 is an apparatus for wireless communication including means for implementing any of aspects 1 to 17.
Aspect 35 is an apparatus for wireless communication including means for implementing any of aspects 18 to 29.
Aspect 36 is a computer-readable medium (e.g., a non-transitory computer-readable medium) storing computer executable code, where the code when executed by a processor causes the processor to implement any of aspects 1 to 17.
Aspect 37 is a computer-readable medium (e.g., a non-transitory computer-readable medium) storing computer executable code, where the code when executed by a processor causes the processor to implement any of aspects 18 to 29.

1. An apparatus for wireless communication at a first user equipment (UE), comprising:
a memory; and
at least one processor coupled to the memory and, based at least in part on information stored in the memory, the at least one processor is configured to:
receive, based on a first power state of a reconfigurable intelligent surface (RIS), at least one of a positioning session configuration or a sensing session configuration;
receive an indication of a power state schedule of the RIS; and perform, based on at least one of the positioning session configuration or the sensing session configuration and the power state schedule of the RIS, at least one of a set of measurements or a set of transmissions for at least one of a positioning session or a sensing session.

2. The apparatus of claim 1, wherein the at least one processor is further configured to:
output an indication of at least one of the set of performed measurements or the set of performed transmissions for at least one of the positioning session or the sensing session.

3. The apparatus of claim 2, wherein, to output the indication of at least one of the set of performed measurements or the set of performed transmissions, the at least one processor is configured to:
transmit the indication of at least one of the set of performed measurements or the set of performed transmissions.

4. The apparatus of claim 2, wherein, to output the indication of at least one of the set of performed measurements or the set of performed transmissions, the at least one processor is configured to:
store, in a first memory or a cache, the indication of at least one of the set of performed measurements or the set of performed transmissions.

5. The apparatus of claim 1, wherein the power state schedule comprises a pattern of one or more power-on states and one or more power-off states of the RIS, wherein the pattern is associated with a particular starting slot.

6. The apparatus of claim 1, wherein the power state schedule comprises a time window in which a pattern of one or more power-on states and one or more power-off states is applied to the RIS.

7. The apparatus of claim 1, wherein the power state schedule includes an indication of at least one of a number of beams of the RIS, a shape of the beams of the RIS, or a direction of the beams of the RIS when the RIS is in a power-on state.

8. The apparatus of claim 1, wherein, to receive the indication of the power state schedule, the at least one processor is configured to receive the indication of the power state schedule from a network node via one of layer 1 (L1) signaling, layer 2 (L2) signaling, or layer 3 (L3) signaling.

9. The apparatus of claim 1 wherein, to receive the indication of the power state schedule, the at least one processor is configured to receive the indication of the power state schedule from a location management function (LMF) via one of a positioning system information block (pos-SIB) or long-term evolution (LTE) positioning protocol (LPP) signaling.

10. The apparatus of claim 1, wherein the at least one processor is further configured to:
transmit, based on a second power state of the RIS, at least one of a set of reference signal time difference (RSTD) measurement values or a set of relative time difference (RTD) values.

11. The apparatus of claim 1, wherein the power state schedule is one of a dynamic configuration or a semi-static configuration.

12. The apparatus of claim 1, wherein the at least one processor is further configured to:
transmit, to a second UE via one of sidelink control information (SCI), radio resource control (RRC) signaling, or UE-to-UE signaling, the power state schedule.

13. The apparatus of claim 1, wherein the at least one processor is further configured to:
transmit, to a location management function (LMF), a measurement report indicating a second power state of the RIS in accordance with the power state schedule.

14. The apparatus of claim 1, wherein the at least one processor is further configured to:
transmit, to a second UE, a measurement report indicating a second power state of the RIS in accordance with the power state schedule.

15. The apparatus of claim 1, wherein, to receive at least one of the positioning session configuration or the sensing session configuration, the at least one processor is configured to:
receive at least one of the positioning session configuration or the sensing session configuration from at least one of a network entity, a network node, or a second UE.

16. The apparatus of claim 1, wherein the at least one processor is further configured to:
transmit at least one of an area identifier of the first UE or an identifier of the RIS, wherein, to receive the indication of the power state schedule of the RIS, the at least one processor is configured to receive the indication of the power state schedule of the RIS based at least on the area identifier of the first UE or the identifier of the RIS.

17. The apparatus of claim 1, wherein the at least one processor is further configured to:
transmit a second power state of the RIS in accordance with the power state schedule to a sensing entity.

18. An apparatus for wireless communication at a network node, comprising:
a memory; and
at least one processor coupled to the memory and, based at least in part on information stored in the memory, the at least one processor is configured to:
transmit, based on a first power state of a reconfigurable intelligent surface (RIS), at least one of a positioning session configuration or a sensing session configuration; and
transmit an indication of a power state schedule of the RIS.

19. The apparatus of claim 18, wherein the network node is a location management function (LMF), a base station, or a user equipment (UE).

20-28. (canceled)

29. A method of wireless communication at a first user equipment (UE), comprising:
receiving, based on a first power state of a reconfigurable intelligent surface (RIS), at least one of a positioning session configuration or a sensing session configuration; receiving an indication of a power state schedule of the RIS; and performing, based on at least one of the positioning session configuration or the sensing session configuration and the power state schedule of the RIS, at least one of a set of measurements or a set of transmissions for at least one of a positioning session or a sensing session.

30. (canceled)
